(19) United States
(12) Patent Application Publication
(10) Pub. No.: US 2010/0191789 A1
(43) Pub. Date: Jul. 29, 2010

(54) METHOD FOR REGULATING AN ACTUAL VALUE OF A VARIABLE CHARACTERIZING A POSITION OF AN ACTUATOR, COMPUTER PROGRAM PRODUCT, COMPUTER PROGRAM, AND RECORDING MEDIUM

(76) Inventors: Alexandre Poty, Impasse Maitre Jean Bordeaux (FR); Patrick Lanusse, Gradignan (FR); Alain Oustaloup, Talence (FR); Pierre Melchior, Andernos (FR); Olivier Cois, Kernen i. R. (DE); Ralf Buehrle, Hochberg (DE)

Correspondence Address: KENYON & KENYON LLP, ONE BROADWAY, NEW YORK, NY, 10004, US

(21) Appl. No.: 12/087,803

(22) PCT Filed: Jan. 22, 2007
(86) PCT No.: PCT/EP2007/050577

§ 371 Date: Apr. 9, 2010

(30) Foreign Application Priority Data
Jan. 24, 2006 (DE) 102006003251.9

(51) Int. Cl. G06F 17/14

(52) U.S. Cl. 708/270; 708/400

(57) ABSTRACT

A method is provided for regulating an actual value of a variable, which characterizes a position of an actuator, to a setpoint value using a regulator, which method makes it possible to optimize regulation in terms of bandwidth, stability, accuracy, and sturdiness. A predefined time characteristic of the setpoint value is transformed into a desired time characteristic of the actual value. A first transfer function is formed in the frequency domain and is approximated using one or more factors, in particular delay elements, to transform the predefined time characteristic of the setpoint value into the desired time characteristic of the actual value. A nonintegral exponent is selected for at least one of the factors.

### BACKGROUND INFORMATION

The present invention is directed to a method for regulating an actual value of a variable characterizing a position of an actuator, a computer program product, a computer program, and a recording medium according to the definition of the species in the independent claims.

Methods for regulating an actual value of a variable characterizing a position of an actuator to a setpoint value with the aid of a regulator are already sufficiently well-known. It is also known that a predefined time characteristic of the setpoint value may be transformed to a desired time characteristic of the actual value, a transfer function in the frequency range being formed for transformation of the predefined time characteristic of the setpoint value into the desired time characteristic of the actual value and being approximated by one or more factors. These factors are usually proportional time elements (PT) of an integral order, i.e., having integral exponents. Furthermore, the use of CRONE regulators which utilize the properties of a novel mathematical operator that generalizes the concept of derivations of a nonintegral order is also known from the publication “La commande CRONE, du scalaire au Multivariable” [The CRONE Control, from Scalar to Multivariable], A. Oustaloup and B. Mathieu, Hermes, 1999.

### DISCLOSURE OF THE INVENTION

### Summary of the Invention

The method according to the present invention for regulating an actual value of a variable characterizing a position of an actuator, the computer program product according to the present invention, the computer program according to the present invention, and the recording medium according to the present invention having the features of the independent claims have the advantage over the related art in that a nonintegral exponent is selected for at least one of the factors of the transfer function for transforming the predefined time characteristic of the setpoint value into the desired time characteristic of the actual value.

In this way, considerably more degrees of freedom are available in the form of the nonintegral exponent of the at least one of the factors than in the case of factors with exclusively integral exponents. Furthermore, the number of required factors may be minimized in this way and thus the number of required parameters of the transfer functions may also be minimized. Formation of the transfer function may thus also be implemented more rapidly and requires less computation and memory capacity.

The formation or modeling of the transfer function in the frequency range as described here allows an excellent regulating performance in the form of an optimal compromise between bandwidth, stability, accuracy, and sturdiness of the regulation on the basis of a nonintegral exponent of the at least one of the factors. Furthermore, the transition function apparently has a linear structure which does not require the regulator parameters to be adapted as a function of engine characteristics maps and operating conditions. Finally, the period of time required for calibration of the regulation [system] is very short on the basis of the above-mentioned reduced number of parameters as well as the linear properties of the transfer function, thus allowing the use of the linear regulation theory during calibration and thus helping to avoid repeated and time-consuming calibration tests.

Advantageous refinements of and improvements on the method defined in the main claim are possible through the measures identified in the subclaims.

It is advantageous in particular when a characteristic of the first transfer function in the frequency range is determined, when the first transfer function thereby determined is approximated by one or more straight-line segments, for each of which a factor of the first transfer function representing the particular straight-line segment is determined, at least one of the factors having a nonintegral exponent. In this way, the desired first transfer function in the frequency range may be represented in a particularly simple manner and with less complexity in the form of a mathematical function.

To do so, the characteristic of the desired first transfer function in the frequency range may easily be determined at first numerically.

It is also advantageous that the characteristic of the desired first transfer function is determined in the form of a Bode diagram which then allows extremely simple conversion to the factor(s).

It is advantageous in particular if the predefined characteristic of the setpoint value is transformed into a desired characteristic of the setpoint value via a filter and if a second transfer function as the transfer function of the filter is formed by division of the approximated first transfer function by the transfer function of the regulator and of the actuator. The desired first transfer function may then be implemented particularly easily in this way with the help of the filter at a given transfer performance of the regulator and the actuator.

It is advantageous in particular if a CRONE regulator is used as the regulator. The desired first transfer function may be implemented easily in particular using the at least one factor and its nonintegral exponents in this way because the CRONE regulator also allows the use of a transfer function having at least one factor whose exponent is not an integer.

### BRIEF DESCRIPTION OF THE DRAWINGS

An exemplary embodiment of the present invention is illustrated in the drawings and explained in greater detail in the following description.

FIG. 1 shows a block diagram of a regulated system;

FIG. 2 shows a block diagram of a complete regulating system having a prefilter;

FIG. 3 shows a Bode diagram of a desired characteristic of an amplitude of a transfer function in the frequency range;

FIG. 4 shows an approximation of the desired characteristic of FIG. 3 by a PT1 element;

FIG. 5 shows an approximation of the desired characteristic of the transfer function of FIG. 3 by multiple PTn elements, and

FIG. 6 shows an approximation of the desired characteristic of the transfer function of FIG. 3 by two PT elements having nonintegral exponents;

FIG. 7 shows a flow chart for an exemplary sequence of the method according to the present invention.

### DETAILED DESCRIPTION OF THE INVENTION

FIG. 1 shows a function diagram for regulating the position of an electronic actuator 1 of an internal combustion engine. Electronic actuator 1 is used to control the internal combustion engine, for example, and may be, for example, a throttle valve, an exhaust gas recirculation valve, a waste gate valve or an actuator for varying the geometry of a turbine of an exhaust gas turbocharger.

Electronic actuator 1 includes an electric torque source 4, which is designed as a dc motor, for example. Electric torque source 4 is connected to a power transformer 3, which supplies the required electric power to electric torque source 4 according to an input control signal u. Power transformer 3 may be designed as a variable voltage source or current source, for example, and may be designed in particular for delivering a pulse-width-modulated voltage or current signal. Accordingly, input signal u corresponds to a voltage value U, a current value I or a pulse duty factor α. Electric torque source 4 triggers a load 6 to a rotational or translatory movement via a kinematic transfer element 5. Load 6 may be the flap of a throttle valve or of an exhaust gas recirculation valve, for example. Kinematic transfer element 5 typically includes transmission elements having nonlinear properties, if possible, such as adhesive friction, sliding friction and/or coulomb friction or variable gear ratios. Kinematic transfer element 5 may also include a linkage of mechanical springs which force load 6 to return back to a predefined position when no torque is being predefined by the electric torque source. A position indicator unit 7 is connected to load 6 and ascertains an actual value Y for the position of load 6.

Electronic actuator 1 is connected to a control device 2, which is embodied as a microprocessor-based drive train control, for example. Control device 2 receives actual value Y from position indicator unit 7 and delivers control signal u to power transformer 3. To regulate the position of electric actuator 1, control device 2 performs a position regulating algorithm 8 which periodically determines novel values of control signal u as a function of received actual value y and a predefined setpoint value y_{ref}. Predefined setpoint value y_{ref} is made available, for example, by an air system management algorithm 9 in a manner known to those skilled in the art, e.g., as a function of an accelerator pedal position. In the example according to FIG. 1, air system management algorithm 9 is also implemented in control device 2.

Position regulating algorithm 8 and air system management algorithm 9 may be implemented in the hardware and/or software in control device 2 or in separate control devices. Additional input and output variables of control device 2 are labeled with reference numerals 25 and 30, respectively, in FIG. 1. Input variables 25 include, for example, the accelerator pedal position, as mentioned above, as well as additional operating variables of the internal combustion engine, such as the engine rotational speed and the engine load, e.g., as a function of an air flow rate supplied to the internal combustion engine or an intake manifold pressure. Output variables 30 of control device 2 includes, for example, variables for setting an ignition point in time in the case of a gasoline engine or triggering additional valves or electric actuators, e.g., exhaust gas recirculation valve, waste gate valve, injection valve, etc. which may be implemented according to the described design of electric actuator 1.

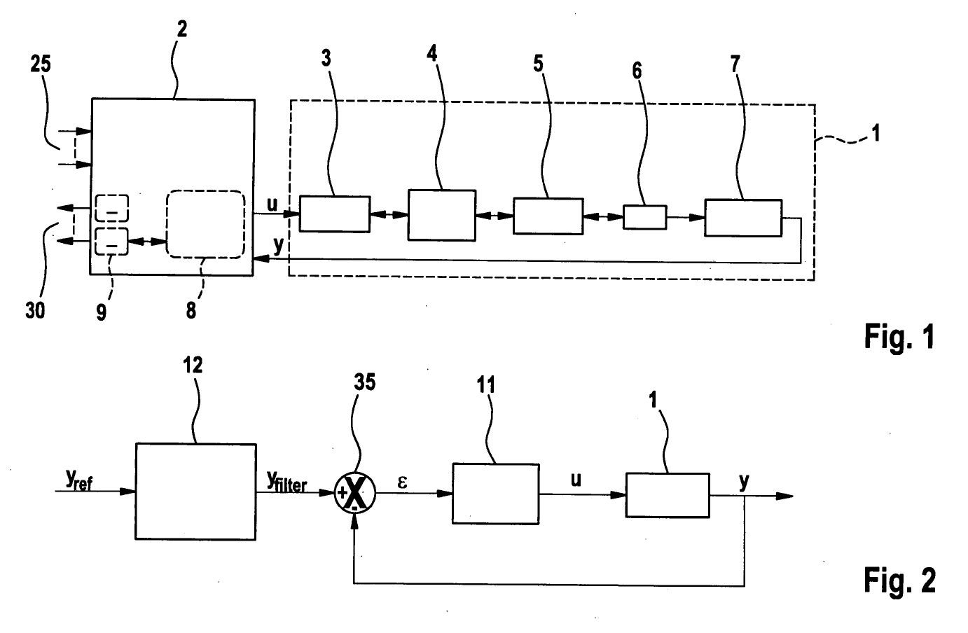

According to FIG. 2, position regulating algorithm 8 includes a prefilter 12 which receives a predefined time characteristic of setpoint value y_{ref}. Prefilter 12 filters the predefined time characteristic of setpoint value y_{ref} and delivers a filtered time characteristic of setpoint value y_{filter} at its output. In a node 35, a control deviation c is then formed by subtracting the time characteristic of actual value y from the filter time characteristic of setpoint value y_{filter}. Control deviation ε is then sent to a regulator 11 which ascertains control signal u for minimizing control deviation ε as a function of control deviation ε and delivers it to electronic actuator 1. Regulator 11 may be implemented, for example, as a P regulator, an I regulator, a D regulator, a PI regulator, a PD regulator, a PID regulator or in a particularly advantageous manner as a CRONE regulator according to the publication “The CRONE Control, from Scalar to Multivariable,” A. Oustaloup and B. Mathieu, Hermes, 1991 and in the latter case may have a factor of the transfer function in the frequency range with nonintegral exponents. It shall be assumed below as an example that regulator 11 is designed as a CRONE regulator.

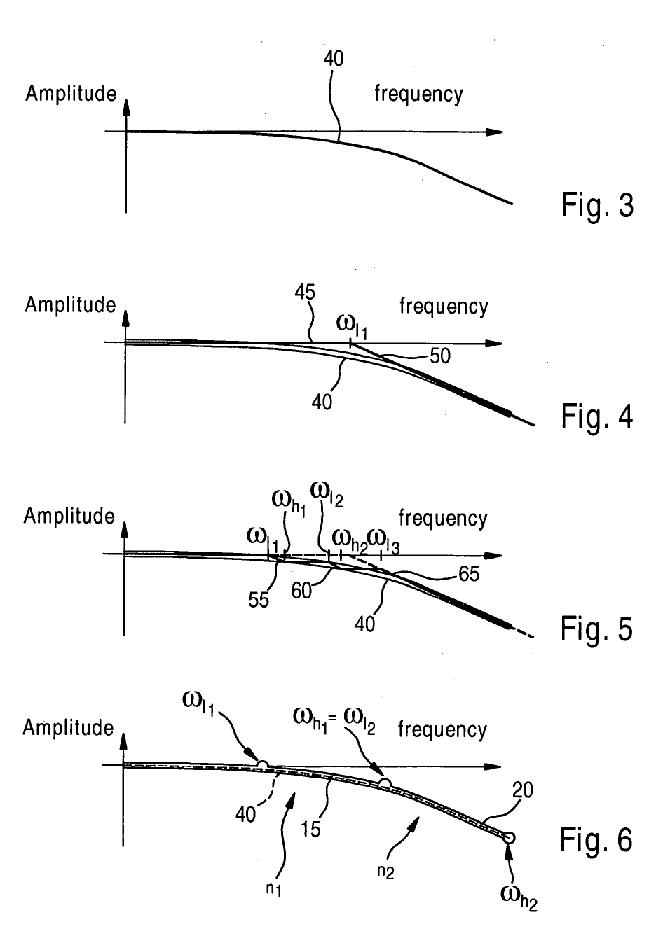

In implementation of a regulating system having a prefilter 12, a logic gate 35, a regulator 11, and an electronic actuator 1, as depicted in FIG. 2, first a desired first transfer function is formed in the frequency range for transformation of the predefined time characteristic of setpoint value y_{ref} into a desired time characteristic of actual value y. The required characteristic of the desired first transfer function in the frequency range may then be determined, e.g., with the help of numerical approximation methods, i.e., by nonmathematical analysis. The characteristic of the desired first transfer function may advantageously be determined in the form of a Bode diagram as shown in FIG. 3, for example, where the amplitude of the desired first transfer function is plotted as a function of frequency and labeled by using reference numeral 40. The characteristic of the amplitude of the desired first transfer function over the frequency which was ascertained numerically in this example by using a Bode diagram is approximated by a mathematical function. In the past this has been done, for example, by using a PT1 element (proportional time element of the first order) as shown in FIG. 4. Characteristic 40 is then approximated by a first straight-line segment 45 having slope 0 and a second straight-line segment 50 having a negative slope as shown in FIG. 4. The negative slope of second straight-line segment 50 amounts to 20 dB/decade in logarithmic representation as in the example according to FIG. 4, so the desired first transfer function is represented as follows by the transfer function of a PT1 element by a approximation using mathematical analysis:

$${H}_{PT 1} = {( \frac{1}{1 + \frac{s}{{ω}_{{l}_{1}}}} )}^{1} . \qquad ( 1 )$$

In equation (1) s denotes the Laplace variable in the frequency range and ωₗ_{ᵢ} is the lower cutoff frequency at which second straight-line segment 50 in the frequency range begins.

A better approximation of characteristic 40 is obtained by approximating according to FIG. 5 the desired transfer function via mathematical analysis by the product of the transfer functions of multiple PT elements of the n-th order, where n is an integer. Thus in the example according to FIG. 5, characteristic 40 is approximated by three straight-line segments having slope 0 and three straight-line segments having different negative slopes. In FIG. 5 the approximation performed according to FIG. 4 using a PT1 element is shown by a dotted line. By using multiple straight-line segments having different negative slopes, characteristic 40 is approximated better than by using only the PT1 element according to FIG. 4. A straight-line segment having a negative slope is labeled by reference numeral 55 in FIG. 5, a second straight-line segment having a negative slope is labeled by reference numeral 60 and a third straight-line segment having a negative slope is labeled by reference numeral 65. First straight-line segment 55 has a negative slope of 20 dB/decade in a logarithmic representation. Second straight-line segment 60 has a negative slope of 40 dB/decade in a logarithmic representation. Third straight-line segment 65 has a negative slope of 20 dB/decade in a logarithmic representation. Thus first straight-line segment 55 and third straight-line segment 65 are each represented by a PT1 element using mathematical analysis, whereas second straight-line segment 60 may be represented by a PT2 element using mathematical analysis. This yields the following equation for the transfer function of characteristic 40 approximated using mathematical analysis according to FIG. 5:

$${H}_{PTn} = {\prod }_{k = 1}^{K} {( \frac{1 + \frac{s}{{ω}_{{h}_{k}}}}{1 + \frac{s}{{ω}_{{l}_{k}}}} )}^{{n}_{k}} = {( \frac{1 + \frac{s}{{ω}_{{h}_{1}}}}{1 + \frac{s}{{ω}_{{l}_{1}}}} )}^{1} {( \frac{1 + \frac{s}{{ω}_{{h}_{2}}}}{1 + \frac{s}{{ω}_{{l}_{2}}}} )}^{2} {( \frac{1 + \frac{s}{{ω}_{{h}_{3}}}}{1 + \frac{s}{{ω}_{{l}_{3}}}} )}^{1} . \qquad ( 2 )$$

K is the number of factors in equation (2) and in this example K=3; nₖ is the integral order of the particular factor.

In this equation, ωₗ_{ᵢ} is the lower cutoff frequency of first straight-line segment 55 and ωₕ_{ᵢ} is the upper cutoff frequency of first straight-line segment 55. ωₗ_{₂} is the lower cutoff frequency of second straight-line segment 60 and ωₕ_{ᵢ} is the upper cutoff frequency of second straight-line segment 60. ωₗ_{₃} is the lower cutoff frequency of third straight-line segment 65 and ωₕ_{ᵢ} is the upper cutoff frequency of third straight-line segment 65.

It is apparent according to FIGS. 4 and 5 that only straight-line segments having a slope of integral multiples of the value 20 dB/decade in a logarithmic representation are achievable using integral exponents of the factors of transfer functions H_{PT1} and/or H_{PTn}, which are approximated by mathematical analysis. The closer the approximation by mathematical analysis to characteristic 40, the more PTn elements are necessary.

According to the present invention, it is therefore proposed that characteristic 40 according to FIG. 6 should be approximated not only by using one straight-line segment having slope 0 but by using two other straight-line segments of a negative slope, which simulate characteristic 40 as optimally as possible. This approximation is better than the approximation according to FIG. 5 and nevertheless has fewer straight-line segments. This is due to the fact that straight-line segments 15, 20 having a negative slope each have a slope value which is not an integral multiple of 20 dB/decade. Accordingly, there are also no integral exponents for the factors of the first transfer function desired which has been approximated by mathematical analysis according to FIG. 6.

Instead, these exponents may each assume a rational, not necessarily integral, value. Thus in the example according to FIG. 6, the following equation is obtained for the approximation using mathematical analysis of the desired transfer function:

$${H}_{PT fractional} = {\prod }_{k = 1}^{K} {( \frac{1 + \frac{s}{{ω}_{{h}_{k}}}}{1 + \frac{s}{{ω}_{{l}_{k}}}} )}^{{n}_{k}} = {( \frac{1 + \frac{s}{{ω}_{{h}_{1}}}}{1 + \frac{s}{{ω}_{{l}_{1}}}} )}^{{n}_{1}} ⋆ {( \frac{1 + \frac{s}{{ω}_{{h}_{2}}}}{1 + \frac{s}{{ω}_{{l}_{2}}}} )}^{{n}_{2}} . \qquad ( 3 )$$

Where K is the number of factors in equation (3), i.e., K=2; nₖ is the rational component order of the particular factor; ωₗ_{ᵢ} is the lower cutoff frequency of first straight-line segment 15 having a negative slope for approximation of characteristic 40 according to FIG. 6 and ωₕ_{₁} is the upper cutoff frequency of first straight-line segment 15; ωl₂ is the lower cutoff frequency of second straight-line segment 20 having a negative slope for approximation of characteristic 40 according to FIG. 6 and ω₂ is the upper cutoff frequency of second straight-line segment 20.

The factor having exponent n₁ in equation (3) is thus assigned to first straight-line segment 15, and the factor having exponent n₂ is assigned to second straight-line segment 20. There is a linear relationship between exponent nₖ and the slope of the particular straight-line segment in a logarithmic representation. For example, nₖ=0.5 with an absolute value of 10 dB/decade of the negative slope of the assigned straight-line segment. Exponent nₖ is equal to 0.25 with an absolute value of 5 dB/decade of the negative slope of the particular straight-line segment. Exponent nₖ is equal to 0.75 with an absolute value of 15 dB/decade of the negative slope of the particular straight-line segment. Integral multiples of 20 dB/decade for the absolute value of the negative slope of a straight-line segment are each expressed by an integral exponent, as is also the case in FIGS. 4 and 5. H_{PT fractional} is thus the approximation using mathematical analysis of the desired first transfer function between the predefined time characteristic of setpoint value y_{ref} and the desired time characteristic of actual value y. In comparison with the function H_{PTn} and function H_{PT1} according to FIGS. 4 and 5, function H_{PT fractional} is much closer to desired characteristic 40 and requires far fewer parameters, at least in comparison with function H_{PTn}. Due to the use of proportional time elements having rational but not necessarily integral exponents in function H_{PT fractional}, this yields infinitely more degrees of freedom in comparison with any desired function H_{PTn} having exclusively integral exponents. Furthermore, function H_{PT fractional} requires a much lower number K of factors for the same approximation to desired characteristic 40 and thus also a considerably lower number of parameters nₖ, ωₗ_{ₖ} and ωₕ_{ₖ}, where k=1, . . . , K than a mathematical analytical transfer function having only integral exponents.

Parameters nₖ, ωₗ_{ₖ} and ωₕ_{ₖ} where k=1, K of the mathematical analytical transfer function H_{PT fractional} according to equation (3) are determined in the frequency range via the Bode diagram according to FIG. 6, as has already been described. Depending on the physical boundary conditions of the entire regulating system depicted in FIG. 2, parameters nₖ, ωₗ_{ₖ} and/or ωₕ_{ₖ} must be further modified, however. These physical boundary conditions may include, for example, cutoff values for the maximum allowed voltage or the maximum allowed current for triggering electric torque source 4. Parameters nₖ, ωₗ_{ₖ} and/or ωₕ_{ₖ} must be further modified, if necessary as a function of the physical performance of electronic actuator 1 in the frequency range, to be able to fulfill the physical boundary conditions of the regulating system with regard to power and sturdiness in particular.

Under some circumstances, this may take place at the expense of accuracy for approximation of characteristic 40 by the mathematical analytical function according to equation (3). According to equation (3), the mathematical analytical transfer function approximating the characteristic of the desired first transfer function may have one or more factors, depending on how many straight-line segments having a slope not equal to 0 are used for approximation of characteristic 40, where K denotes the number of these straight-line segments and may thus assume integral values greater than or equal to 1. According to the present invention, transfer function H_{PT fractional} according to equation (3) obtained by mathematical analysis includes at least one factor having a nonintegral exponent.

The following discussion relates to the dimensioning of prefilter 12. To do so, first the transfer function of prefilter 12, which is also referred to below as the second transfer function, is determined. It transforms the predefined time characteristic of setpoint value y_{ref} into the desired filter time characteristic of setpoint value y_{filter}. Starting from transfer function H_{PT fractional} according to equation (3), second transfer function F_{fractional} is obtained from transfer function H_{PT fractional} of equation (3) as follows:

$${F}_{fractional} = ( \frac{{H}_{PTfractional}}{T} ) . \qquad ( 4 )$$

In this equation, T is the transfer function of regulator 11 and of electronic actuator 1 in the frequency range and is ascertained as known to those skilled in the art. F_{fractional} according to equation (4) is thus the transfer function of prefilter 12 in the frequency range. Second transfer function F_{fractional} is then transformed back into the time range by methods known to those skilled in the art and is transformed into a time-discrete transfer function F_{z}(z) in the time range according to the following form for implementation in a control unit program of control device 2:

$${F}_{z} ( z ) = \frac{{\sum }_{k = 0}^{{N}_{num}} {b}_{k} {z}^{- k}}{{\sum }_{k = 0}^{{N}_{den}} {a}_{k} {z}^{- k}} . \qquad ( 5 )$$

In this equation, z is the discrete time variable, and aₖ, bₖ, N_{den}, Nₙᵤₘ are the parameters of time-discrete transfer function F_{z}(z) resulting from the transformation described here. The described reverse transformation from second transfer function F_{fractional} of equation (4) to time-discrete transfer F_{z}(z) according to equation (5) is not always possible using mathematical analysis, so that an approximation solution may have to be found for this reverse transformation, if necessary, which may be performed with the help of the Bode diagram in the frequency range in the manner known to those skilled in the art.

For the case according to the present invention, in which at least one of the factors of transfer function H_{PT fractional} according to equation (3) has a nonintegral exponent, as a rule, second transfer function F_{fractional} according to equation (4) is also obtained with at least one factor having a nonintegral exponent. If the regulator is also designed as a CRONE regulator whose transfer function, which is designated as a third transfer function, also has at least one factor having a nonintegral exponent, then the regulating system according to FIG. 2 may be adjusted using the maximum number of degrees of freedom and the minimum number of parameters with regard to the greatest possible bandwidth, stability, accuracy, and sturdiness and using the least possible time and memory capacity.

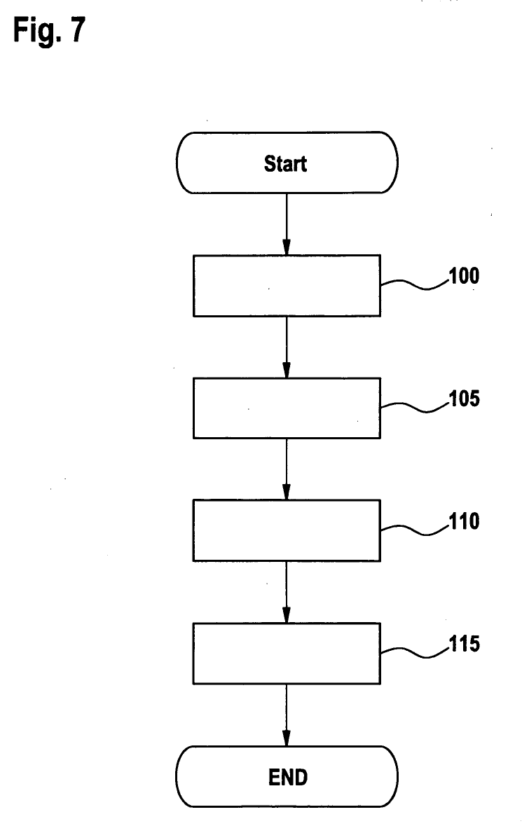

FIG. 7 shows a flow chart for an exemplary sequence of the method according to the present invention. After the start of the program, at program point 100, the characteristic of the desired first transfer function in the frequency range is ascertained in the manner described here, e.g., via a Bode diagram and by numerical approximation with the measure of transforming the predefined time characteristic of setpoint value y_{ref} to the desired time characteristic of actual value y. The sequence next branches off to a program point 105.

At program point 105 according to the procedure described in conjunction with FIG. 6, mathematical analytical transfer function H_{PT fractional} according to equation (3) is ascertained from desired characteristic 40 of the amplitude of the transfer function in the frequency range.

The sequence then branches off to a program point 110.

At program point 110, second transfer function F_{fractional} is ascertained from transfer function H_{PT fractional} and transfer function T of regulator 11 and of electric actuator 1 according to equation (4), ascertained by a method known to those skilled in the art. The sequence then branches off to a program point 115.

At program point 115, second transfer function F_{fractional} of equation (4) is, if necessary, transformed in the manner described here by approximation with the help of the Bode diagram in the frequency range into time-discrete transfer function F_{z}(z) according to equation (5), which may then be implemented in the software and/or hardware in a control unit program of control device 2.

The program is then terminated.

The sequence of the method according to the present invention may be performed in a program code-controlled manner, e.g., by a computer program which performs all the steps of the sequence plan according to FIG. 7 when the computer program is executed in a computer such as a microprocessor of control device 2. To this end, the program code may also be stored on a machine-readable carrier or recording medium and may thus form a computer program product. The machine-readable carrier or recording medium may be fixedly installed in control device 2 or may be supplied from the outside via a hard drive of the control device for readout and execution of all steps of the program code.

The method according to the present invention may be used for example in the control unit of an internal combustion engine, e.g., a gasoline engine or a diesel engine.

The principle of fractional differentiation on which the present invention is based is protected by the following protective rights of École Nationale Superieure d'Électronique, Informatique et Radiocommunication de Bordeaux (ENSEIRB) at the French Institute for Intellectual Property:

### No. 78.357.28 of Dec. 14, 1978

### No. 90.046.13 of Mar. 30, 1990

### No. 96.640.468 of Aug. 28, 1996.

Furthermore, by the following protective rights of ENSEIRB, which are registered with the French Agency for the Protection of Programs (APP):

### No. 93.30.006.00 of Jul. 28, 1993

### (IDDN.FR.001.300006.00.R.P.1993.000.00000)

### No. 94.11.015.00 of Mar. 16, 1994

(IDDN.FR.001.110015.00.R.P.1994.000.00000).

1-10. (canceled)

11. A method for regulating an actual value of a variable characterizing a position of an actuator to a setpoint value using a regulator, comprising:
forming a first transfer function in the frequency domain for transformation of a predefined time characteristic of the setpoint value into a desired time characteristic of the actual value, wherein the first transfer function is approximated by at least one factor including a nonintegral exponent; and
transforming the predefined time characteristic of the setpoint value into the desired time characteristic of the actual value using the first transfer function.

12. The method as recited in claim 11, wherein a characteristic of the first transfer function in the frequency domain is determined, the first transfer function is approximated by at least one straight-line segment, and a factor representing the at least one straight-line segment of the first transfer function is determined, the factor having a nonintegral exponent.

13. The method as recited in claim 12, wherein the characteristic of the first transfer function is determined numerically in the frequency domain.

14. The method as recited in claim 12, wherein the characteristic of the first transfer function is determined in the form of a Bode diagram.

15. The method as recited in claim 12, wherein the predefined characteristic of the setpoint value is transformed into a desired characteristic of the setpoint value with the aid of a filter, and wherein a second transfer function is formed as the transfer function of the filter by division of the approximated first transfer function by a transfer function of the regulator.

16. The method as recited in claim 15, wherein a CRONE regulator is used as the regulator.

17. The method as recited in claim 16, wherein a third transfer function is selected as the transfer function of the CRONE regulator using at least one factor having a nonintegral exponent.

18. A computer-readable storage medium for storing a computer program having a plurality of codes which, when executed on a computer, controls a method for regulating an actual value of a variable characterizing a position of an actuator to a setpoint value using a regulator, the method comprising:
forming a first transfer function in the frequency domain for transformation of a predefined time characteristic of the setpoint value into a desired time characteristic of the actual value, wherein the first transfer function is approximated by at least one factor including a nonintegral exponent; and
transforming the predefined time characteristic of the setpoint value into the desired time characteristic of the actual value using the first transfer function.
